(19) United States
(12) Patent Application Publication
(10) Pub. No.: US 2012/0009367 A1
(43) Pub. Date: Jan. 12, 2012

(54) Pot and Preparation Methods of a Glass Fiber Reinforced Materials

(76) Inventor: MENQ-FONG SHIEH, Tainan (TW)

(21) Appl. No.: 12/832,055

(22) Filed: Jul. 7, 2010

(51) Int. Cl. B32B 1/02; B28B 1/087

(52) U.S. Cl. 428/34.5; 264/71

(57) ABSTRACT

The present invention provides a pot made of glass fiber reinforced materials. The pot includes three components of A, B, C. The weight ratio of A, B, C components is 100:250 to 300:0.8 to 12. Where, component A includes 25 to 50 parts of weight of water-based resin, component B includes 50 to 75 parts of weight of water-based glue, component C includes 60 to 100 parts of weight of water and 0.2 to 1.5 parts of weight of acid. Component B is plaster; components C, including 1.08 to 19.0 parts of weight of glass fiber, 0 to 4.09 parts of weight of chemical fiber, and 0 to 4.09 parts of weight of glass fiber cloth. The invention also provides the preparation of the glass fiber reinforced materials pot. The pot has the following advantages: not easy to damage, easy to transport, environmental, quick prototyping and so on.

### TECHNOLOGY FIELD

This invention relates to a pot of glass fiber reinforced materials and the preparation of the pot.

### BACKGROUND TECHNOLOGY

With the continuous improvement of living standards, more and more people began to use flowers to beautify living spaces. Meanwhile, the flower is also widely used to beautify the urban environment, especially in the major holiday or significant events. It often requires a million pots of flowers, which means to demand lots of pots.

Nowadays, most currently used are ceramic flower pots, ceramic pots are eco-friendly and conducive to the growth of the flowers. However, ceramic pot also has some disadvantages. First of all, ceramic flower pots are made of clay or kaolin clay firing, when the pots are in great demand, it shall need to consume a large amount of natural resources, and ultimately increase costs and restrict output owing to the shortage of natural resources. Secondly, it needs a long time to porcelain bodies at high temperature above 1000 degrees Celsius (hereinafter referred to as “° C.”) fired to make ceramic pots and consumes a lot of energy. Thirdly, the production of ceramic pots are complex, through pan off, mud pile, throwing, printing blank, repairing blank, pressing down the water, drawing blank, glazing and firing pottery, ceramics and other processes, especially for the large flower pots, firing is very difficult, and the finished product rate is low. As we all know, ceramic pots are fragile, which will bring great troubles for carrying ceramic pots.

Because ceramic pots with these shortcomings, there are some pots made by other materials, such as wooden or plastic pots. Among them, the wooden pots are expensive, they are not widely used; durable but lightweight, but the plastic pots are impermeable, impervious. They are difficult to adapt to growing flowers, and long-term in nature they cannot be degraded completely, causing “white pollution.”

Invention Content

The purpose of this invention is to provide a method of creating simple, non-fragile glass-fiber reinforcement pots, the described pot includes A, B, C components, and the weight ratio of described components A, B, C is 100:250 to 300:0.8 to 12.

Wherein component A includes 25 to 50 parts of weight of water-based resin, 50 to 75 parts of weight of water-based glue, 60 to 100 parts of weight of water, and 0.2 to 1.5 parts of weight of inorganic acid. The mentioned component B is gypsum; the above component C includes 1.08 to 19.0 parts of weight of glass fiber, 0 to 4.09 parts of weight of chemical fiber, and 0 to 4.09 parts of weight of glass fiber cloth.

Optimally, the weight ratio of above components A, B, C is 100:300:0.8 to 12.

Optimally, the described water-based acrylic resin is the styrene-acrylic emulsion or polyacrylic emulsion. Optimally, the described water-based glue is the polyethylene water glue. Optimally, the described concentration of inorganic acid is 98 percent (hereinafter referred to as “%”) (weight) of phosphoric acid.

Optimally, the above component B is hosphogypsum or citric acid. Optimally, the described chemical fiber is polyester fiber or polypropylene fiber, the mentioned glass fiber is low-alkali fiber cloth, or treated laminated fiber cloth or mesh cloth. The invention also provides the preparation methods of the glass fiber reinforcement pots; the preparation methods include the following steps:

A. A mixture of components A, B, C obtained in accordance with the 100:250 to 300:0.8 to 12 mixed by weight ratio, wherein component A includes 25 to 50 parts of weight of water-based resin, 50 to 75 parts of weight of water-based glue, 60 to 100 parts of weight of water, and 0.2 to 1.5 parts of weight of inorganic acid. The mentioned component B is plaster; component C includes 1.08 to 19.0 parts of weight of glass fiber, 0 to 4.09 parts of weight of chemical fiber, and 0 to 4.09 parts of weight of glass fiber cloth.
B. Evenly brush the above mixture on the internal model and the mold core of the die;
C. Cover fully with fiber cloth on above mold core, and then assemble mold; and
D. Take mold statically to the platform or vibrate it on the vibrator, and then open the mold to place the finished product.

Optimally, the weight ratio of the mixture brushed on the internal mold and the mixture on the mold core mixture is 75 to 100:25, the weight ratio of the mixture brushed on the internal mold and the mixture on the mold core mixture is 3:1.

Optimally, the vibration time is 0.5 to 2 minutes, the placement time of 10 to 15 minutes.

Optimally, it includes brushing release agent in the model box mouth and outside the mold core, the release agent described as siloxane compounds.

Since the invention of the pots of glass fiber reinforced materials is mainly made of gypsum, and it adds a certain amount of glass fiber and chemical fiber. In which the invention of glass fiber reinforced materials can withstand 80 kilogram (hereinafter referred to as “kg”) of pressure, and ceramic pots can only withstand 20 kg of pressure. Therefore, compared with the ceramic pot, the invention of the pot of glass fiber reinforced materials have higher strength, it is unbreakable and easy to transport. For the same size of pots, the weight of present invention of the pot of glass fiber reinforced materials as 1000 gram (hereinafter referred to as “g”), while the weight of ceramic pots for the 1500 g. Accordingly, the weight of glass fiber reinforcement pot compared with the same size of ceramic pot is smaller, which makes the invention of glass fiber reinforcement pot easy to carry.

The invention of glass-fiber reinforcement pot also has the advantages of fast prototyping, it requires only less than 20 minutes that you can open the mold, remove the finished product after assembling mold, and ceramic pot needs to burn about dozens of hours. Accordingly, the invention of glass fiber reinforced materials facilitates a large scale to produce pots. The invention of the entire glass fiber reinforcement manufacturing process of the pot is carried out at room temperature. It does not like ceramic pot, requiring energy consumption, so production costs are lower.

In addition, the invention of the pot of glass fiber reinforced materials is biodegradable. It does not like plastic pots to produce as “white pollution”. It has environmental advantages.

Since the invention of the pots of glass fiber reinforcement is formed at room temperature, you can use any pigment (or dye), and ceramic pot requires high temperature above 1000° C. to burn, so the temperature resistance of pigments lower than 1000° C. cannot use. Accordingly, the invention of glass fiber reinforcement pot has no limitations in the color effect.

### Preferred Implementation Methods

To give a specific way for the inspector to know more about the structure, features and other purposes of the present invention, now we combined with the attached details below of the good implementation of the cases. The better implementation of the cases described in the present invention is only used for the purpose of the technical solution, but not to limit the invention.

### EXAMPLE 1

According to the following formula for the preparation of glass Fiber reinforcement flower mixture:

| | | |
|---|---|---|
| Styrene-acrylic emulsion | 25 | parts by weight |
| Polyethylene p water base cement | 50 | parts by weight |
| Concentration of 98% (weight) phosphoric acid | 0.2 | parts by weight |
| Water | 60 | parts by weight |
| Phosphogypsum | 338 | parts by weight |
| Glass fiber | 1.08 | parts by weight |

Stir the above mixture to make it mixed. Then brush mixture evenly into the internal model and mold core of the die, in which, the mixture weight ratio of brushing to the internal model and the mold core is 75:25. Full covered with cloth in the mold core, until the mixture does not covered, and then assemble mold. Place the die Statically or vibrate in the vibrator 0.5 minutes, then remove from the vibrator and put place it 10 minutes and then open mold to remove the finished product.

Remove the finished product, clean up off-cut, waste of mold box, core and silicon rubber mould, then brush siloxane compound in the mold box mouth and outside the core to keep mold cleaning.

The implementation of the case of the prepared glass fiber reinforcement flower weight is 350 to 2000 g, it can withstand the pressure of 60 to 180 kg.

### EXAMPLE 2

According to the following formula for the preparation of glass Fiber reinforcement flower mixture:

| | | |
|---|---|---|
| Styrene-acrylic emulsion | 30 | parts by weight |
| Polyethylene water base cement | 60 | parts by weight |
| Concentration of 98% (weight) phosphoric acid | 1 | parts by weight |
| Water | 80 | parts by weight |
| Citric acid | 478.8 | parts by weight |
| Glass fiber | 10 | parts by weight |
| Polypropylene fiber | 3 | parts by weight |

Stir the above mixture to make it mixed. Then brush mixture evenly into the internal model and mold core of the die, in which, the mixture weight ratio of brushing to the internal model and the mold core is 90:25. Full covered with cloth in the mold core, until the mixture does not covered, and then assemble mold. Place the die Statically or vibrate in the vibrator 2 minutes, then remove from the vibrator and put place it 15 minutes and then open mold to remove the finished product.

Remove the finished product, clean up off-cut, waste of mold box, core and silicon rubber mould, and then brush siloxane compound in the mold box mouth and outside the core to keep mold cleaning.

The implementation of the case of the prepared glass fiber reinforcement flower weight is preferably between about 350 and about 2000 g, it can preferably withstand the pressure of between about 60 and about 180 kg.

### EXAMPLE 3

According to the following formula for the preparation of glass Fiber reinforcement flower mixture:

| | | |
|---|---|---|
| Styrene-acrylic emulsion | 50 | parts by weight |
| Polyethylene water base cement | 75 | parts by weight |
| Concentration of 98% (weight) phosphoric acid | 1.5 | parts by weight |
| Water | 100 | parts by weight |
| Citric acid | 679.5 | parts by weight |
| Glass fiber | 19.0 | parts by weight |
| Glass fiber cloth | 4.09 | parts by weight |
| Polypropylene fiber | 4.09 | parts by weight |

Stir the above mixture to make it mixed. Then brush mixture evenly into the internal model and mold core of the die, in which, the mixture weight ratio of brushing to the internal model and the mold core is 100:25. Full covered with cloth in the mold core, until the mixture does not covered, and then assemble mold. Place the die Statically or vibrate in the vibrator 1 minutes, then remove from the vibrator and put place it 12 minutes and then open mold to remove the finished product.

Remove the finished product, clean up off-cut, waste of mold box, core and silicon rubber mould, and then brush siloxane compound in the mold box mouth and outside the core to keep mold cleaning.

The implementation of the case of the prepared glass fiber reinforcement flower weight is 350 to 2000 g, it can withstand the pressure of 60 to 180 kg.

It requires to declare that the above contents and specific way of implementing the invention is intended to prove that the present invention is the practical application of technical solutions, it should not be construed as limited the protection scope of this invention. The technical staff in the field of the spirit and principles of this invention can use for various modifications, equivalent replacement or improvement. The extent of protection of this invention is subject to the attached claim.

What is claimed is:

1. A pot of glass fiber reinforced materials includes three components A, B, C, wherein the weight ratio described in components A, B, C is 100:250 to 300:0.8 to 12;
Component A includes 25 to 50 parts of weight of water-based resin, 50 to 75 parts of weight of water-based glue, 60 to 100 parts of weight of water, and 0.2 to 1.5 parts of weight of inorganic acid; Described in component B is plaster;
Described in components C includes 1.08 to 19.0 parts of weight of glass fiber, 0 to 4.09 parts of weight of chemical fiber, and 0 to 4.09 parts of weight of glass fiber cloth.

2. According to claim 1, the characteristic of the pot of glass fiber reinforced material described in components A, B, C of the weight ratio 100:300:0.8 to 12.

3. According to claim 1, the characteristics of the pot of glass fiber reinforced material is that the described water-based resin is styrene-acrylate emulsion or polyacrylic emulsion; the above water-based glue is water-based polyethylene glue; the mentioned inorganic acid concentration of 98% (weight) of phosphoric acid.

4. According to claim 2, the characteristics of the pot of glass fiber reinforced material is that the described water-based resin is styrene-acrylate emulsion or polyacrylic emulsion; the above water-based glue is water-based polyethylene glue; the mentioned inorganic acid concentration of 98% (weight) of phosphoric acid.

5. According to claim 1, the characteristic of the pot of glass fiber reinforced material described in Component B is phosphogypsum or citric acid.

6. According to claim 2, the characteristic of the pot of glass fiber reinforced material described in Component B is phosphogypsum or citric acid.

7. According to claim 1, the characteristics of the pot of glass fiber reinforced materials is described in the chemical fiber is polyester fiber or polypropylene fiber, the glass fiber is low-alkali fiber, or over-processed plastic fiber or mesh cloth.

8. According to claim 2, the characteristics of the pot of glass fiber reinforced materials is described in the chemical fiber is polyester fiber or polypropylene fiber, the glass fiber is low-alkali fiber, or over-processed plastic fiber or mesh cloth.

9. A preparation as the claim 1 described, the preparation of a pot of glass fiber reinforcement comprises the following steps:
A. A mixture of components A, B, C obtained shall comply with the 100:250 to 300:0.8 to 12 mixed by weight ratio; In which component A includes 25 to 50 parts of weight of water-based resin, 50 to 75 parts of weight of water-based glue, 60 to 100 parts of weight of water, and 0.2 to 1.5 parts of weight of inorganic acid; The mentioned component B is plaster; component C includes 1.08 to 19.0 parts of weight of glass fiber, 0 to 4.09 parts of weight of chemical fiber, and 0 to 4.09 parts of weight of glass fiber cloth;
B. Directly pour into or evenly brush the above mixture on the internal model and the mold core of the die;
C. Cover fully with fiber cloth on above mold core, and then assemble mold;
D. Take mold statically to the platform or vibrate it on the vibrator, and then open the mold to place the finished product;

10. According to the method described in claim 9, the characteristics that the weight ratio of the mixture brushed on the internal mold and the mixture on the mold core mixture is 75 to 100:25.

11. According to the method described in claim 10, the characteristics that the weight ratio of the mixture brushed on the internal mold and the mixture on the mold core mixture is 3:1.

12. According to the method described in claim 9, the characteristics that the static placement or vibration time to is 0.5 to 2 minutes, the placement time of 10 to 15 minutes.

13. According to the method described in claim 10, the characteristics still includes brushing release agent in the model box mouth and outside the mold core, the release agent described as siloxane compounds.

14. According to the method described in claim 11, the characteristics still includes brushing release agent in the model box mouth and outside the mold core, the release agent described as siloxane compounds.

15. According to the method described in claim 12, the characteristics still includes brushing release agent in the model box mouth and outside the mold core, the release agent described as siloxane compounds.
